(19) United States
(12) Patent Application Publication
(10) Pub. No.: US 2013/0066495 A1
(43) Pub. Date: Mar. 14, 2013

(54) POWER SUPPLY CONTROL APPARATUS FOR ELECTRIC VEHICLE

(71) Applicant: Toshiyuki Furuta, Shizuoka-ken (JP)

(72) Inventor: Toshiyuki Furuta, Shizuoka-ken (JP)

(73) Assignee: SUZUKI MOTOR CORPORATION, Shizuoka-ken (JP)

(21) Appl. No.: 13/548,960

(22) Filed: Jul. 13, 2012

(30) Foreign Application Priority Data
Sep. 8, 2011 (JP) 2011-195874

(51) Int. Cl. B60W 20/00; B60W 10/08; B60W 10/06

(52) U.S. Cl. 701/22; 903/930

(57) ABSTRACT

A power supply control apparatus for an electric vehicle has its object to promote the continuation of a drive mode in which an engine is operated to charge a battery when a vehicle speed is not less than a predetermined vehicle speed, and suppress the transition to a drive mode in which the engine operates all the time regardless of the vehicle speed, thereby ensuing comfort in the vehicle compartment. A control unit (6) lowers a vehicle speed for starting engine activation (Vst) in an HEV mode 1 as an average value of vehicle speed (Vave) is smaller than a predetermined average value of vehicle speed (Vave-th), or a decrease amount of SOC of a battery (4) is not less than a predetermined amount and as the decrease amount thereof becomes larger.

### CROSS-REFERENCE TO RELATED APPLICATIONS

The present application claims priority to Japanese Patent Application No. 2011-195874, filed Sep. 8, 2011, which is incorporated herein in its entirety.

### BACKGROUND OF THE INVENTION AND RELATED ART STATEMENT

1. Field of the Invention

The present invention relates to a power supply control apparatus for an electric vehicle, particularly to a power supply control apparatus for an electric vehicle which performs an operation mode control for a range-extended electric vehicle (a plug-in type series hybrid vehicle).

2. Description of Related Art

The operation mode of range-extended electric vehicles is broadly divided into two kinds: an “EV mode” in which driving is performed by electric power charged in a battery from the outside, and an “HEV mode” in which driving is performed by using electric power generated by an on-board internal combustion type engine (hereafter, referred to an “engine”) and a generator which is a generator motor, while controlling an SOC (State of Charge) which is a residual battery capacity of the battery, at a predetermined control target value (SOC-HEV).

Further, the “HEV mode” is divided into an “HEV mode 1” with idling stop in which the engine is deactivated when the vehicle speed is zero or a low speed, and an “HEV mode 2” in which when the SOC becomes lower than the target range, falling below a specified value (SOC-H12), the engine is kept operating without performing idling stop until the control target value (SOC-HEV) is recovered.

In FIG. 8, SOC-HEV is a value of battery residual capacity to be maintained in the HEV mode 1. SOC-HE is a value of residual battery capacity at which a shift from the HEV mode 1 to the EV mode takes place. SOC-EH1 is a value of residual battery capacity at which a shift from the EV mode to the HEV mode 1 takes place. SOC-H21 is a value of residual battery capacity at which a shift from the HEV mode 2 to the HEV mode 1 takes place. SOC-H12 is a value of residual battery capacity at which a shift from the HEV mode 1 to the HEV mode 2 takes place.

Then, for the sake of brevity, it is assumed that SOC-HEV, SOC-EH1, and SOC-H21 are the same values.

Under such a situation, in the HEV mode 1, the SOC is maintained centering around SOC-HEV.

Moreover, FIG. 9 shows an example of the change of the SOC when the vehicle is driven from a sufficiently high charged capacity. As shown in FIG. 9, in the EV mode, driving is performed while consuming the power of the battery (where regeneration from the generator is performed). Then, the EV mode shifts to the HEV mode 1 at SOC-HEV, and the SOC thereof is maintained. However, when the SOC falls to or below SOC-H12, the HEV mode 1 shifts to the HEV mode 2, and the generation by the engine continues. Thereafter, when the SOC reaches SOC-HEV, the HEV mode 2 shifts to the HEV mode 1.

Examples of the prior art related to what is described above include the following Japanese Patent No. 3736437.

An air conditioner for a hybrid vehicle relating to Japanese Patent No. 3736437 is configured such that in a hybrid vehicle in which when the state of charge (SOC) of the battery falls to or below a target value to start charging, the battery is charged by driving electric power generation means with a drive engine, the charging of the battery is made to start earlier during operation of the drive engine while the vehicle is driven than during deactivation of the engine while the vehicle is driven, by setting a higher target value to start charging the battery.

As a result of this, the battery is more likely to become in need of charging during operation of the engine; on the other hand, the battery is less likely to become in need of charging during deactivation of the engine, so that the frequency that operation of the engine is started only for charging the battery can be reduced, thus improving the fuel efficiency and reducing the emission of environmentally disruptive materials.

However, although Japanese Patent No. 3736437 described above is effective when the drive engine is in operation, a problem may arise in a range-extended electric vehicle (a plug-in type series hybrid vehicle).

FIG. 10 shows the deactivation/operation of an engine for power generation in an HEV mode 1 and an HEV mode 2. In FIG. 10, Vst is a vehicle speed for starting engine activation in the HEV mode 1.

That is, in some of range-extended electric vehicles, the activation/deactivation of engine is controlled in accordance with the vehicle speed. In the HEV mode 1, when the vehicle is continuously driven at a speed less than the vehicle speed for starting engine activation (Vst), the engine is not activated and, in this case, the SOC to be used as the drive power source will decrease and the HEV mode 1 will be shifted to the HEV mode 2, in which the engine continuously operates, for charging the battery.

In the HEV mode 2, while the vehicle is stopped (V=0) or driven at a low speed (0<V<Vst), the engine will operate for charging the battery even in a situation where there is no or little occurrence of wind noise and road noise, etc. If that's the case, the operating sound of the engine will stand out to reach the occupants, and thus the occupants become likely to feel the operating sound of the engine uncomfortable as noise.

In particular, during vehicle acceleration while the vehicle is driven at a low speed (0<V<Vst) as described above, since large power is required, the engine rotational speed increases as the vehicle accelerates, thereby impairing comfort while driving the vehicle. For example, while the vehicle is driven at an intermediate or high speed (Vst≦V), required power is generated by the engine both in the HEV mode 1 and the HEV mode 2, the difference in engine noise therebetween is small. Further, since the wind noise and road noise from the outside will increase due to an increase of the vehicle speed, the engine noise tends to be not bothering in relative terms.

As so far described, compared with the HEV mode 1, the HEV mode 2 can be said to be a mode which is inferior in quietness, and therefore in merchantability while the vehicle is stopped or driven at a low speed (accelerating). Therefore, it is desirable that the HEV mode 1 can be continued.

### OBJECT AND SUMMARY OF THE INVENTION

Thus, it is an object of the present invention to provide a power supply control apparatus for an electric vehicle, which promotes the continuation of the drive mode in which the engine is operated to charge the battery when the vehicle speed is not less than a predetermined vehicle speed, and suppresses the transition to the drive mode in which the engine operates all the time regardless of the vehicle speed, thereby ensuring comfort in the vehicle compartment.

The present invention provides a power supply control apparatus for an electric vehicle including an engine for driving a generator and a battery for storing electric energy outputted from the generator and supplying power to a driving source of the vehicle, the power supply control apparatus including: SOC detection means for detecting an SOC which is a residual battery capacity of the battery; vehicle speed detection means for detecting a vehicle speed; engine state detection means for detecting an activation or deactivation state of the engine; engine activation means for activating the engine at a vehicle speed (0km/h) not less than a predetermined value; and control means having an HEV mode 1 in which the engine is operated at a vehicle speed (Vst-min˜Vst0km/h) not less than the predetermined value when the SOC of the battery becomes a first SOC, and an HEV mode 2 in which the engine is operated all the time when the SOC of the battery becomes a second SOC which is lower than the first SOC, wherein the control means lowers a vehicle speed for starting engine activation in the HEV mode 1 as an average value of vehicle speed becomes smaller than a predetermined average value of vehicle speed, or when a decrease amount in SOC of the battery is not less than a predetermined amount and as the decrease amount thereof becomes larger.

The power supply control apparatus for an electric vehicle of the present invention can promote the continuation of a drive mode in which an engine is operated to charge a battery when the vehicle speed is not less than a predetermined vehicle speed, and thereby suppress the transition to a drive mode in which the engine is operated all the time regardless of the vehicle speed, thereby ensuring comfort in the vehicle compartment.

### BRIEF DESCRIPTION OF THE DRAWINGS

FIG. 1 is a system block diagram of a power supply control apparatus (an embodiment);

FIG. 2 is a schematic plan view of a vehicle (an embodiment);

FIG. 3 is a flowchart of the control of a vehicle speed for starting engine activation in an HEV mode 1 (an embodiment);

FIG. 4 is a flowchart of the control for increasing power generation in the HEV mode 1 (an embodiment);

FIG. 5 is a diagram showing the vehicle speed for starting engine activation in the HEV mode 1 (an embodiment);

FIG. 6 is a diagram showing an increase in power generation in the HEV mode 1 (an embodiment);

FIG. 7 is a diagram showing the relationship between a coefficient (a) to be multiplied to an increase amount of power generation and the vehicle speed (an alternative embodiment);

FIG. 8 is a diagram showing a transition to each drive mode of an EV mode, an HEV mode 1, and an HEV mode 2 as the result of change of the residual battery capacity (prior art example);

FIG. 9 is a time chart showing the change of SOC when driving is performed from a sufficiently high charged capacity (prior art example); and

FIG. 10 is an explanatory diagram showing the deactivation/operation of the engine (prior art example).

### DETAILED DESCRIPTION OF PREFERRED EMBODIMENTS

The present invention realizes the purpose of ensuring comfort in a vehicle compartment by promoting the continuation of a drive mode in which an engine is operated to charge a battery when the vehicle speed is not less than a predetermined vehicle speed, and thereby suppressing the transition to a drive mode in which the engine operates all the time regardless of the vehicle speed, by changing a vehicle speed for starting engine activation in an HEV mode 1 according to an average value of vehicle speed or a decrease amount of SOC.

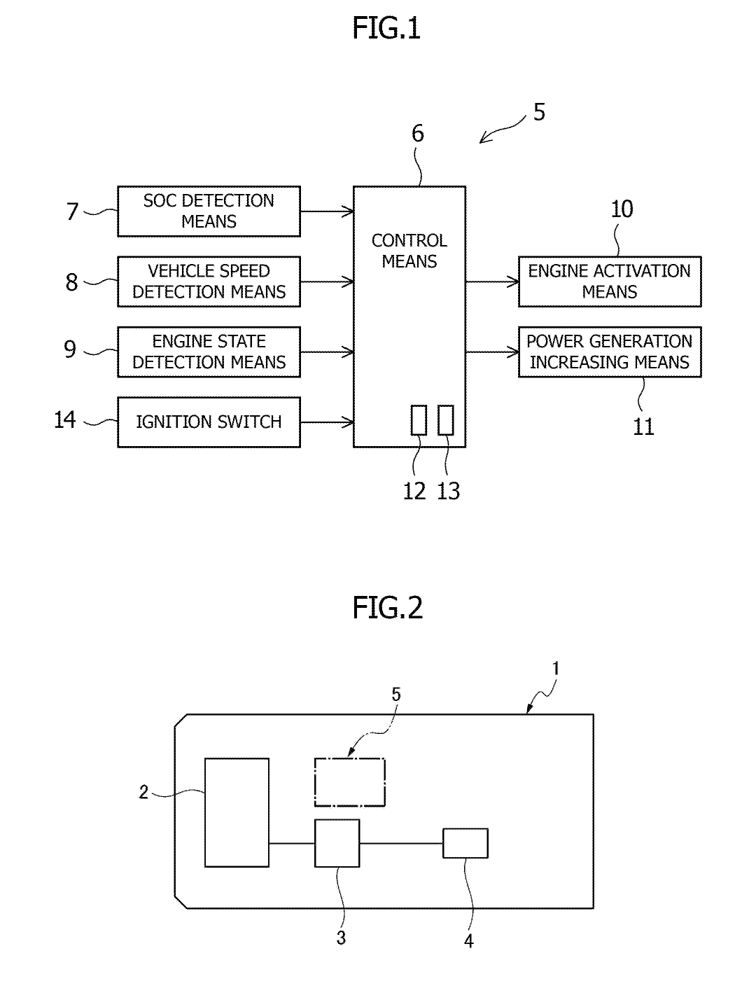

FIGS. 1 to 6 show embodiments of the present invention.

In FIG. 2, a reference numeral 1 denotes a range-extended electric vehicle (a plug-in type series hybrid vehicle)(hereafter, referred to as a “vehicle”). The vehicle 1 includes an internal combustion type engine (hereafter, referred to an “engine”) 2, a generator 3 which is a generator motor driven by the engine 2, and a battery 4 that stores the electric energy outputted from the generator 3 as electric power and supplies electric power to a driving source of the vehicle 1. The generator 3, which is an apparatus having a power generation function to generate electric power, and a driving function to drive the vehicle 1 by use of the electric power of the battery 4, also functions as the driving source of the vehicle 1. It is noted that both the power generation function and the driving function may not be included together in the power generator 3, and configuration may be such that each function is included in a plurality of different instruments.

A power supply control apparatus 5 is provided in the vehicle 1.

The power supply control apparatus 5 is, as shown in FIG. 1, provided with control means (ECU) 6 and is also provided with, in communication with the control means 6, SOC detection means 7 for detecting an SOC (State Of Charge) which is a residual battery capacity, vehicle speed detection means 8 for detecting a vehicle speed, engine state detection means 9 for detecting an activation or deactivation state of the engine 2, engine activation means 10 for activating the engine 2 at a vehicle speed (0km/h) not less than a predetermined value, and power generation increasing means 11 for increasing the power generation under a predetermined condition.

The control means 6 has an HEV mode 1 in which the engine 2 is operated at a vehicle speed (Vst-min˜Vst0km/h) not less than a predetermined value when the SOC of the battery 4 becomes a first SOC, and an HEV mode 2 in which the engine 2 is operated all the time when the SOC of the battery 4 becomes a second SOC which is lower than the first SOC.

Further, the control means 6 is provided with average-vehicle-speed calculation means 12 for calculating average value of the vehicle speed, and SOC-change-amount calculation means 13 for calculating an SOC change amount.

Furthermore, the control means 6 is in communication with an ignition switch 14.

Accordingly, the control means 6 lowers a vehicle speed for starting engine activation (Vst) in the HEV mode 1 as the average value of vehicle speed (Vave) becomes smaller than a predetermined average value of vehicle speed (Vave-th), or when the decrease amount of SOC is not less than a predetermined amount and as the decrease amount thereof becomes larger, which means that the HEV mode 1 is made to continue and be less likely to shift to the HEV mode 2.

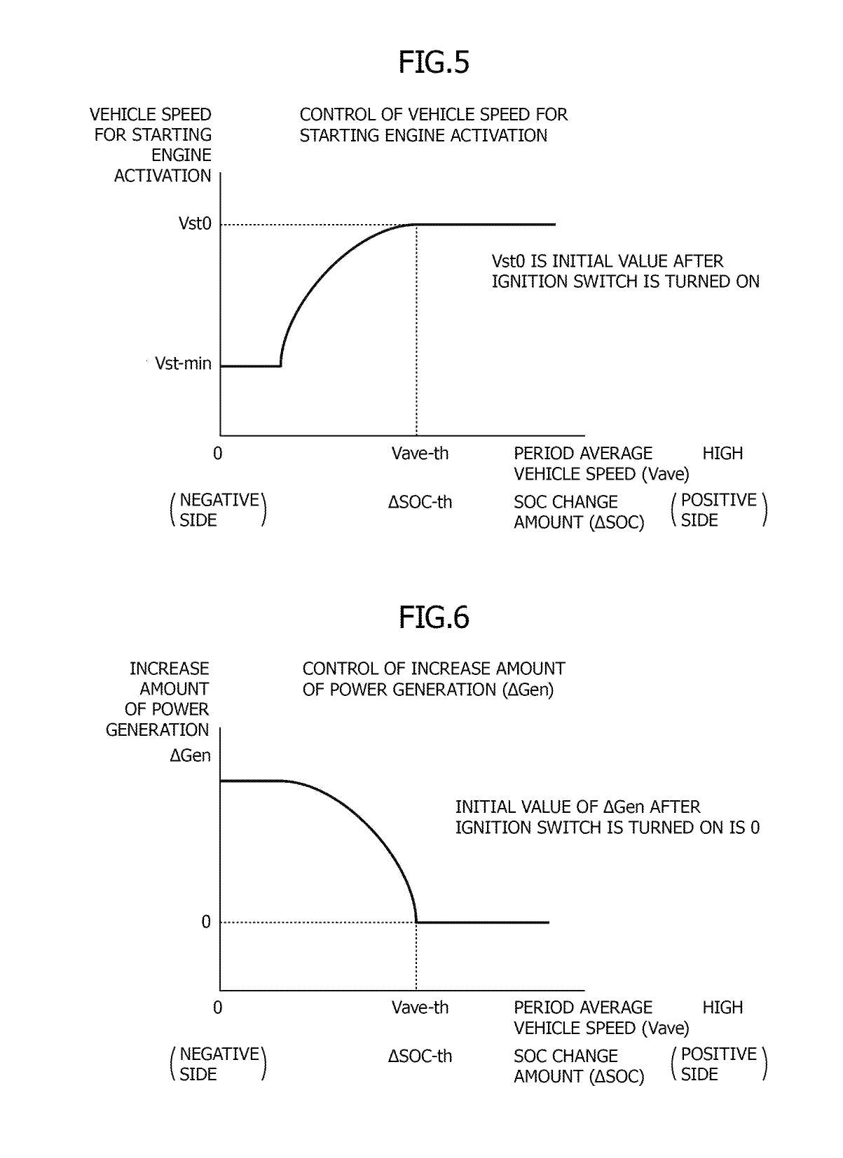

In the control of the vehicle speed for starting engine activation (Vst) in the HEV mode 1, as shown in FIG. 5, an average value of vehicle speed (Vave) and a change amount of SOC (ΔSOC) are determined from a drive history in a predetermined period from the present back to the past. That is, changes of the vehicle speed (V) and the SOC are recorded for each predetermined time, and an average value of vehicle speed (Vave) is determined from the average of vehicle speeds during a predetermined prior period ending at the time of the flow processing, and a change amount of SOC (ΔSOC) is determined from the changes of SOC.

In FIG. 5, if the average value of vehicle speed (Vave) is lower than the predetermined average value of vehicle speed (Vave-th), the engine 2 is activated at a speed lower than an ordinary vehicle speed for starting engine activation (Vst0: an initial value after the ignition switch 14 is turned on).

Moreover, if the change amount of SOC (ΔSOC) is lower than a predetermined change amount of SOC (ΔSOC-th), that is, the decrease amount of SOC is larger than a predetermined value, the engine 2 is activated at a vehicle speed lower than an ordinary vehicle speed for starting engine activation (Vst0).

As the result of this, it is made possible to change the vehicle speed for starting engine activation (Vst) in the HEV mode 1 according to the average value of vehicle speed (Vave) or the decrease amount of SOC, thereby enabling further continuation of the HEV mode 1 in which the engine 2 is activated to charge the battery 4 when the vehicle 1 is driving at a speed not less than a predetermined speed. Thus, since the frequency of the transition to the HEV mode 2, in which the power generation by the engine 2 is performed all the time, can be reduced, it is possible to ensure the comfort in the vehicle compartment.

Further, the control means 6 increases the power generation in the HEV mode 1 as the average value of vehicle speed (Vave) becomes smaller than a predetermined average value of vehicle speed (Vave-th), or the decrease amount of SOC is not less than a predetermined amount and as the decrease amount thereof becomes larger.

In the control to increase the power generation in the HEV mode 1, as shown in FIG. 6, the average value of vehicle speed (Vave) and the change amount of SOC (ΔSOC) are determined from the drive history in a predetermined period from the present back to the past.

In FIG. 6, if the average value of vehicle speed (Vave) is lower than a predetermined average value of vehicle speed (Vave-th), a generation of power larger than ordinarily generated is performed. Moreover, power generation changes time to time according to the required power and electric load at that time. An increase amount of power generation (ΔGen) is the amount of increase with respect to the ordinary amount of power generation. Furthermore, the initial value of the increase amount of power generation (ΔGen) after the ignition switch 14 is turned on is zero (0).

Further, if the change amount of SOC (ΔSOC) is smaller than a predetermined change amount of SOC (ΔSOC-th), that is, the decrease amount of SOC is larger than a predetermined value, a generation of power larger than ordinarily generated is performed.

As the result of this, it is possible to change the power generation in the HEV mode 1 according to the average value of vehicle speed (Vave) or the decrease amount of SOC, thereby enabling further continuation of the HEV mode 1 in which the engine 2 is activated to charge the battery 4 when the vehicle 1 is driving at s speed not less than a predetermined speed. Therefore, since the frequency of the transition to the HEV mode 2, in which the power generation by the engine 2 is performed all the time, can be reduced, it is possible to ensure comfort in the vehicle compartment.

Further, the control means 6 calculates an average value of vehicle speed (Vave) from the average value of vehicle speed (Vave) during a predetermined prior period ending when the engine 2 is detected to be in a deactivation state, and calculates a decrease amount of SOC from the decrease amount of SOC during a predetermined prior period ending when the engine 2 is detected to be in a deactivation state.

As a result of this, it is possible to discriminate the case in which the engine 2 is deactivated and charging of the battery 4 by the driving of the engine 2 is not achieved, and further the vehicle 1 is in a drive state in which charging of the battery 4 cannot not be expected in the HEV mode 1, thus suppressing the transition to the HEV mode 2.

Further, the control means 6 increases power generation as the vehicle speed after the activation of engine increases.

As a result of this, by taking advantage of the phenomenon that sounds other than the engine operating sound, such as the wind noise and road noises increase as the vehicle speed increases, it is possible to increase the amount of engine operation without causing the occupant to be bothered by the operational sound of the engine 2. Therefore, it is possible to charge the battery 4 in an early stage.

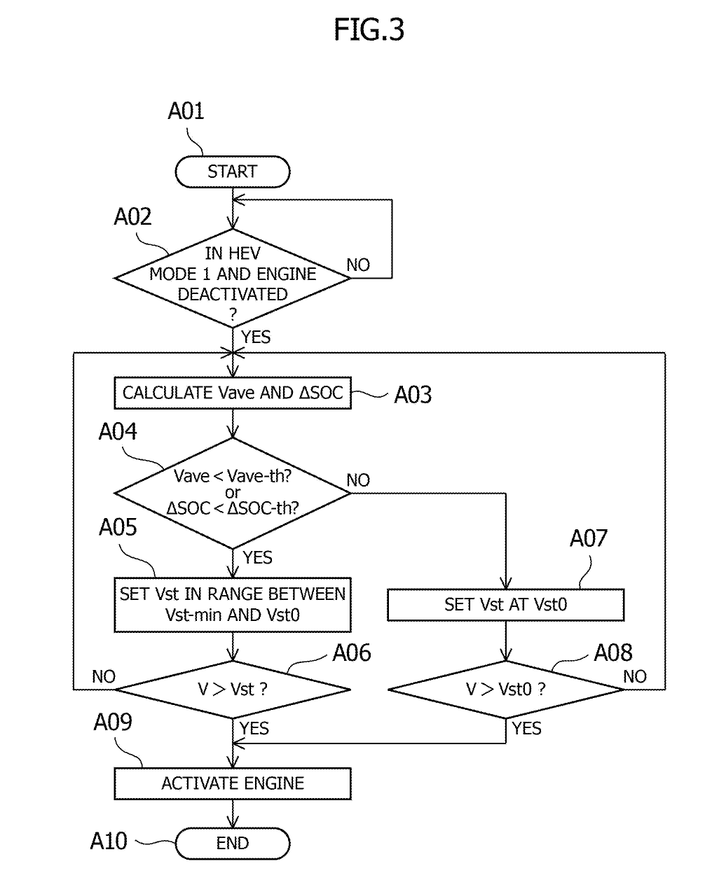

Next, the control of the vehicle speed for starting engine activation (Vst) in the HEV mode 1 will be described based on the flowchart in FIG. 3.

As shown in FIG. 3, when the program starts (step A01), it is judged whether or not the drive mode is the HEV mode 1, and the engine is deactivated (step A02), and when step A02 results in NO, the judgment is continued.

When step A02 results in YES, an average value of vehicle speed (Vave) and a change amount of SOC (ΔSOC) are calculated (step A03), and it is judged whether or not Vave<Vave-th, or ΔSOC<ΔSOC-th (step A04).

When step A04 results in YES, the vehicle speed for starting engine activation is set such that Vst is in a range between Vst-min and Vst0 (step A05). In this case, as Vave becomes smaller than Vave-th, or ΔSOC becomes smaller than ΔSOC-th, it is set such that Vst is closer to Vst-min. Then, it is judged whether or not V>Vst (step A06), and when step A06 results in NO, the process goes back to step A03 described above.

On the other hand, when step A04 results in NO, Vst0 is set to the vehicle speed for starting engine activation (step A07), and it is judged whether or not V>Vst0 (step A08), and when step A08 results in NO, the process goes back to step A03.

When step A08 results in YES, or step A06 described above results in YES, the engine 2 is activated (step A09), and the program is ended (step A10).

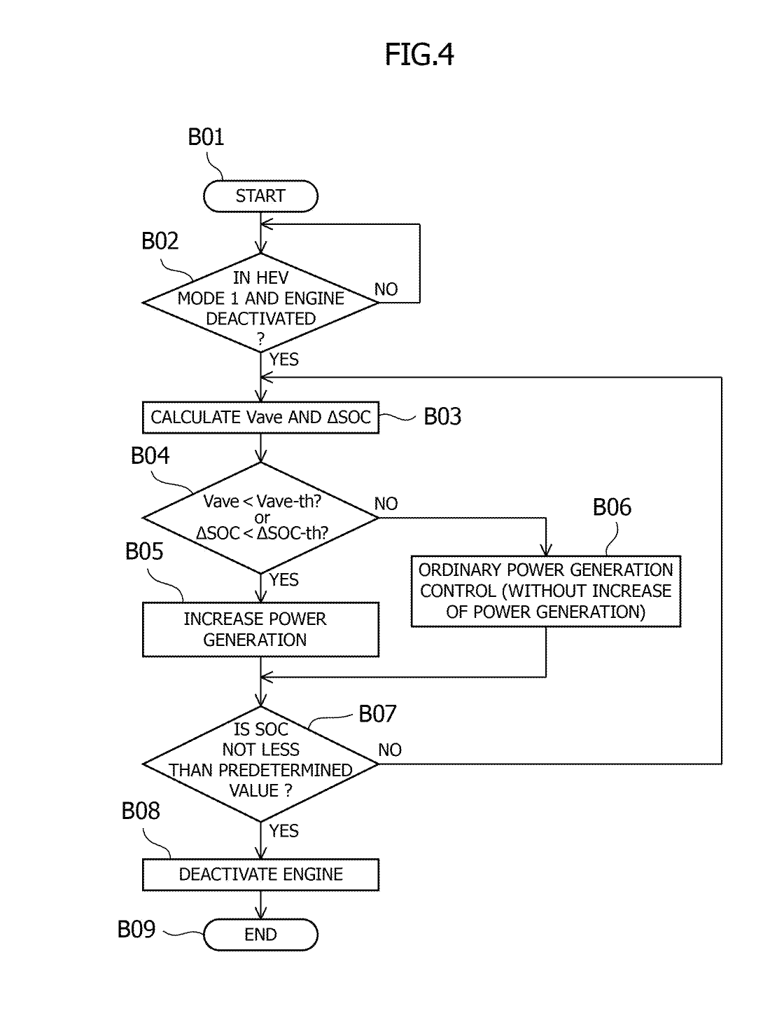

Next, the control to increase the power generation in the HEV mode 1 will be described based on the flowchart of FIG. 4.

As shown in FIG. 4, when the program starts (step B01), it is judged whether or not the drive mode is the HEV mode 1, and the engine is activated (step B02); and when step B02 results in No, this judgment is continued.

When step B02 results in YES, the average value of vehicle speed (Vave) and the change amount of SOC (ΔSOC) are calculated (step B03), and it is judged whether or not Vave<Vave-th or ΔSOC<ΔSOC-th (step B04).

When step B04 results in YES, the power generation is increased by a predetermined increase amount (ΔGen) (step B05).

On the other hand, when step B04 results in NO, ordinary power generation control is performed without increasing power generation (step B06).

After the processing of step B06, or after the processing of step B05, it is judged whether or not SOC is not less than a predetermined value (step B07). It is noted that the predetermined value corresponds to, for example, SOC-HEV in FIG. 8. When step B07 results in NO, the process goes back to step B03.

When step B07 results in YES, the engine 2 is deactivated (step B08) and the program is ended (step B09).

It is noted that in the present invention, as described below, various modifications can be made.

For example, it is also possible to control the vehicle speed for starting engine activation (Vst) and the increase amount of power generation (ΔGen) at the same time.

Moreover, the control of continuation of the mode 1 can be performed such that a switch for an operator to perform selection/non-selection is provided, and execution/non-execution of the control can be performed by the setting of the switch.

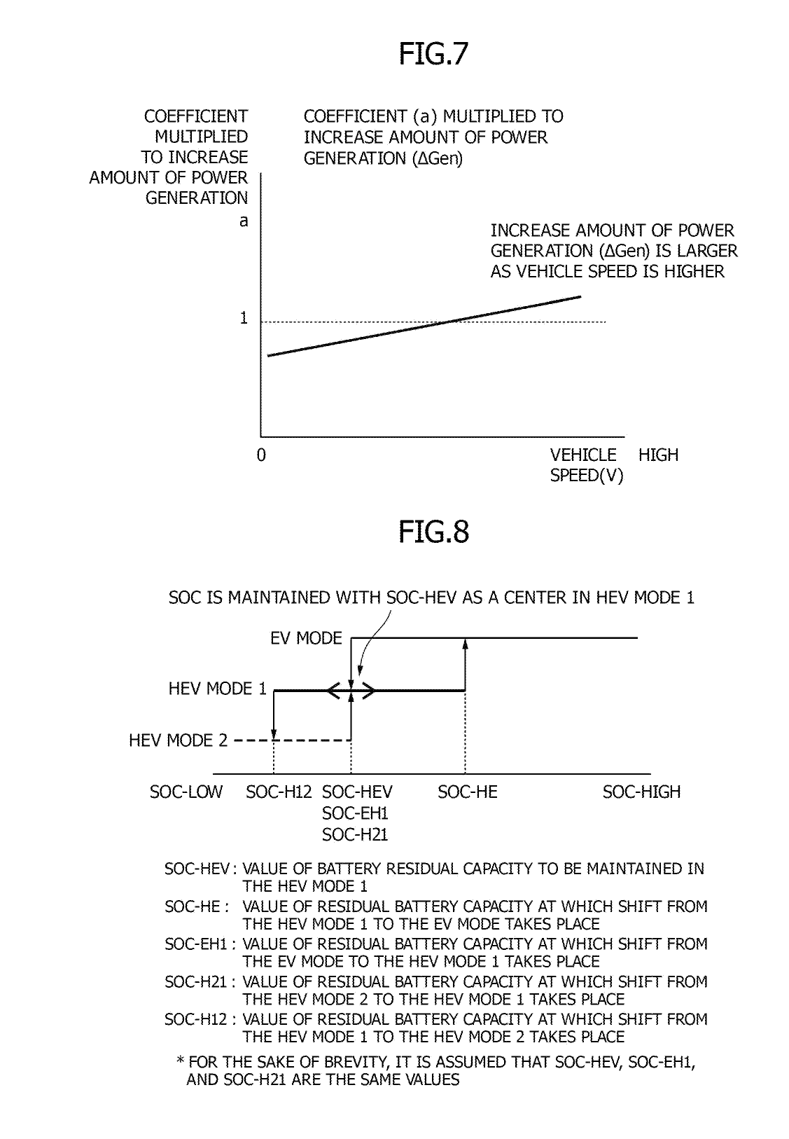

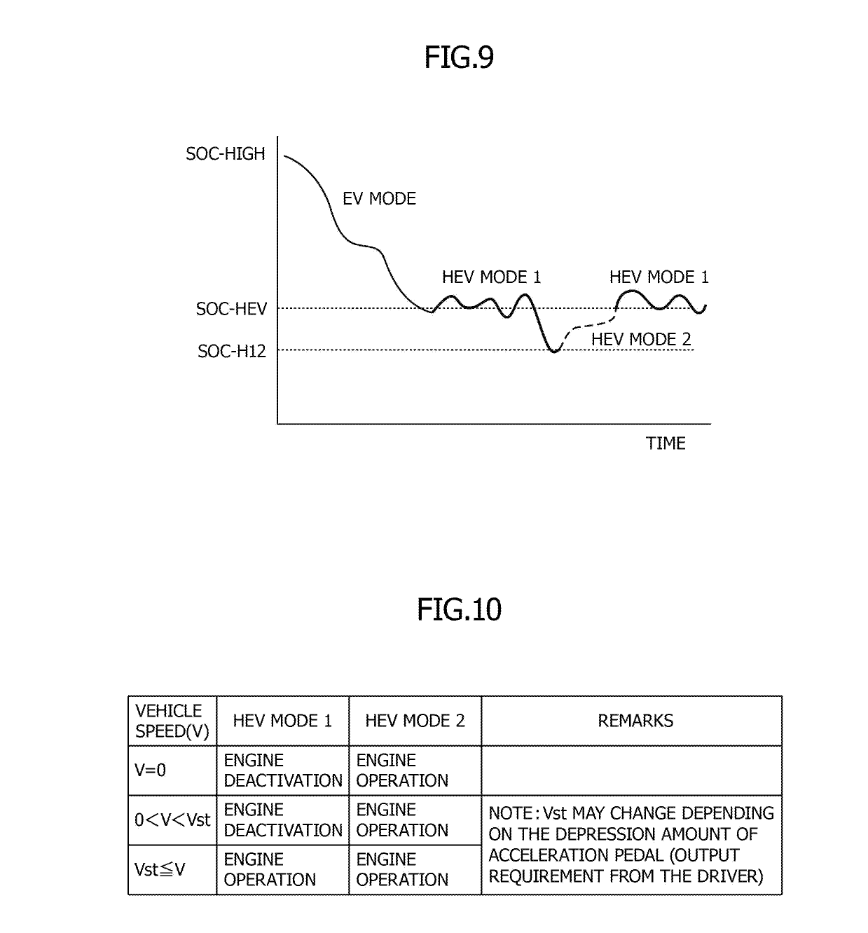

Further, increase amount of power generation (ΔGen), which is a function dependent on the average value of vehicle speed (Vave) or the SOC, can be determined regardless of the vehicle speed. However, when the vehicle speed is low (required power generation is low), and the increase amount (ΔGen) of power generation is large, the increase amount of the engine rotational speed becomes more perceivable, thereby declining sound comfort for the occupants. Therefore, as shown in FIG. 7, a coefficient (a) according to the vehicle speed (V) may be multiplied to the increase amount of power generation (ΔGen).

Furthermore, the control by use of the increase amount (ΔGen) can be applied to the increase amount of power generation in the HEV mode 2.

Moreover, it may be configured such that the control of vehicle speed for starting engine activation (Vst) and the control of the increase amount of power generation (ΔGen) are not performed based on the control of the change amount of SOC (ΔSOC), when SOC is not less than the predetermined SOC (absolute value).

The power supply control apparatus relating to the present invention is applicable to various vehicles.

### DESCRIPTION OF SYMBOLS

1 Vehicle
2 Engine
3 Generator
4 Battery
5 Power supply control apparatus
6 Control means
7 SOC detection means
8 Vehicle speed detection means
9 Engine state detection means
10 Engine activation means
11 Power generation increasing means
12 Average-vehicle-speed calculation means
13 SOC-change-amount calculation means
14 Ignition switch

What is claimed is:

1. A power supply control apparatus for an electric vehicle including an engine for driving a generator and a battery for storing electric energy outputted from the generator and supplying power to a driving source of the vehicle; the power supply control apparatus comprising:
SOC detection means for detecting an SOC which is a residual battery capacity of the battery;
vehicle speed detection means for detecting a vehicle speed;
engine state detection means for detecting an activation or deactivation state of the engine;
engine activation means for activating the engine at a vehicle speed (0km/h) not less than a predetermined value; and
control means having an HEV mode 1 in which the engine is operated at a vehicle speed (Vst-min˜Vst0km/h) not less than the predetermined value when the SOC of the battery becomes a first SOC, and an HEV mode 2 in which the engine is operated all the time when the SOC of the battery becomes a second SOC which is lower than the first SOC, wherein
the control means lowers a vehicle speed for starting engine activation in the HEV mode 1 as an average value of vehicle speed becomes smaller than a predetermined average value of vehicle speed, or when a decrease amount in SOC of the battery is not less than a predetermined amount and as the decrease amount thereof becomes larger.

2. A power supply control apparatus for an electric vehicle including an engine for driving a generator and a battery for storing electric energy outputted from the generator and supplying power to a driving source of the vehicle; the power supply control apparatus comprising:
SOC detection means for detecting an SOC which is a residual battery capacity of the battery;
vehicle speed detection means for detecting a vehicle speed;
engine state detection means for detecting an activation or deactivation state of the engine;
engine activation means for activating the engine at a vehicle speed (0km/h) not less than a predetermined value; and
control means having an HEV mode 1 in which the engine is operated at a vehicle speed (Vst-min˜Vst0km/h) not less than the predetermined value when the SOC of the battery becomes a first SOC, and an HEV mode 2 in which the engine is operated all the time when the SOC of the battery becomes a second SOC which is lower than the first SOC, wherein
the control means increases a power generation in the HEV mode 1 as an average value of vehicle speed becomes smaller than a predetermined average value of vehicle speed, or when a decrease amount in SOC of the battery is not less than a predetermined amount and as the decrease amount thereof becomes larger.

3. The power supply control apparatus for an electric vehicle according to claim 1, wherein
the control means calculates the average value of vehicle speed from an average value of vehicle speed during a predetermined prior period ending when the engine is detected to be in a deactivation state, and calculates a decrease amount of the SOC of the battery from a decrease amount of SOC during a predetermined prior period ending when the engine is detected to be in a deactivation state.

3. The power supply control apparatus for an electric vehicle according to claim 2, wherein
the control means calculates the average value of vehicle speed from an average value of vehicle speed during a predetermined prior period ending when the engine is detected to be in a deactivation state, and calculates a decrease amount of the SOC of the battery from a decrease amount of SOC during a predetermined prior period ending when the engine is detected to be in a deactivation state.

4. The power supply control apparatus for an electric vehicle according to claim 2, wherein the control means further increase power generation as the vehicle speed after the activation of the engine is higher.
